(19) United States
(12) Patent Application Publication
(10) Pub. No.: US 2011/0056252 A1
(43) Pub. Date: Mar. 10, 2011

(54) IMPROVEMENTS TO SECURITY SYSTEMS

(76) Inventor: Robert David Simpson, Hertfordshire (GB)

(21) Appl. No.: 12/597,751

(22) PCT Filed: Apr. 25, 2008
(86) PCT No.: PCT/GB08/01429

§ 371 Date: Jan. 25, 2010

(30) Foreign Application Priority Data
Apr. 27, 2007 (GB) 0708162.3
Sep. 8, 2007 (GB) 0715487.5
Oct. 31, 2007 (US) 11/981372
Feb. 2, 2008 (GB) 0801952.3

(51) Int. Cl. E05B 65/00; F16M 13/00; G08B 21/00; H04N 7/18

(52) U.S. Cl. 70/77; 248/311.2; 340/665; 340/540; 348/143; 348/E07.085

(57) ABSTRACT

A security device for a closure leaf such as a door or window comprises: a link member extending between a portion of said security device located on said closure leaf to which said link member is attached, in use, and a portion of said security device located adjacent to said closure leaf to which said link member is attached, in use; whereby said link member restrains the opening of said closure leaf beyond a predetermined degree; a canister of pressurised substance; a canister holder for securing said canister on a support structure; whereby said canister is in a position for spraying a subject in the vicinity of said closure leaf; and an actuator which engages said link member and which applies pressure to said canister when pressure is exerted on said closure leaf beyond a predetermined level; whereby said canister sprays.

This application is a national stage entry of PCT/GB2008/001429 filed Apr. 25, 2008, under the International Convention claiming priority over GB application No. 0708162.3 filed Apr. 27, 2007; GB application No. 0715487.5 filed Aug. 9, 2007; U.S. application Ser. No. 11/981,372 filed Oct. 31, 2007; and GB application No. 0801952.3 filed Feb. 2, 2008.

### FIELD OF THE INVENTION

The invention relates to security systems and/or security devices and/or canister holders.

### BACKGROUND TO THE INVENTION AND PRIOR ART KNOWN TO THE APPLICANT

The closest prior art documents are the inventor's own prior applications and in particular WO03016663 and WO0073609.

A number of inventions are presented in this application which relate to the single inventive concept of improving security systems where doors are still capable of being opened to at least some degree.

The following prior art is acknowledged: U.S. Pat. No. 5,402,000 and U.S. Pat. No. 4,062,303.

### SUMMARY OF THE INVENTION

In a first broad independent aspect, the invention provides a security device for a closure leaf such as a door or window comprising: a link member extending between a portion of said security device located on said closure leaf to which said link member is attached, in use, and a portion of said security device located adjacent to said closure leaf to which said link member is attached, in use; whereby said link member restrains the opening of said closure leaf beyond a predetermined degree; a canister of pressurized substance; a canister holder for securing said canister on a support structure; whereby said canister is in a position for spraying a subject in the vicinity of said closure leaf; and an actuator which engages said link member and which applies pressure to said canister when pressure is exerted on said closure leaf beyond a predetermined level; whereby said canister sprays.

This configuration is particularly advantageous because it allows triggering by tension applied on a link member. It therefore allows operation with minimal numbers of components. It allows canisters to be placed for spraying at a door opening.

In a subsidiary aspect in accordance with the invention's first broad independent aspect, said actuator incorporates a lever which is pivotally mounted to said canister holder and which engages said link member; whereby when said link member is in sufficient tension said lever causes said canister to spray. This allows pressure applied to the canister to be enhanced.

In a further subsidiary aspect, said lever incorporates a restraining component which is breakable only when a predetermined pressure level is breached. This allows accidental triggering to be avoided in certain modes of operation.

In a further subsidiary aspect, the device further comprises a mount to which the lever is mounted and said restraining component is a shearable pin extending through said lever and its mount. This achieves a one use safety device which avoids complex electronic alternatives.

In a further subsidiary aspect, said security device further incorporates an audible alarm. This configuration achieves a synergistic effect on an intruder.

In a further subsidiary aspect, said lever incorporates a cam portion which engages and lifts said canister against said holder in order to activate it. This configuration also improves the effectiveness of the triggering of the spraying.

In a further subsidiary aspect, said actuator further comprises a disc member located underneath said canister against which a lever applies pressure in use. This avoids inadvertent puncture of the canister.

In a further subsidiary aspect, two or more disc members are connected together via one or more spring members. This further ensures triggering whilst avoiding puncturing the canister.

In a further subsidiary aspect, said canister incorporates a button for triggering the spraying located at the upper portion of the canister and a spraying duct located laterally; said device further comprising a housing which acts as a canister holder and which incorporates at least one side aperture corresponding to the spraying duct of said canister. This allows the holder to be used for a wider variety of door opening embodiments.

In a further subsidiary aspect, said housing incorporates two side apertures located on opposite sides of said housing.

In a further subsidiary aspect, said actuator incorporates electrical or electronic circuitry which activates an audible alarm and/or liquid sprayer.

In a second broad independent aspect, the invention provides a security system for a closure leaf such as a door or window comprising a unit which pops into sight when the closure leaf is open and which returns to a retracted position as the leaf is closed, characterized in that said unit incorporates a powered security component which is switched on when the unit is in its popped out position.

This configuration is particularly advantageous because it allows improved security of a door for example without being visible before the door is opened. The system also is particularly advantageous because it allows the door or window to operate in its conventional fashion so that it doesn't affect the conventional use of the door.

In a subsidiary aspect, said security component is a camera. In combination with the feature of the second aspect, it allows the lens of the camera to be protected when not in use. It therefore limits any risk of damage which would occur should the camera be exposed in all modes of use.

In a further subsidiary aspect, said security component is a sprayer. In combination with the feature of the second aspect, it allows the spray nozzle to be protected from its environment when the door is shut which would avoid any clogging of the nozzle.

In a further subsidiary aspect, said unit is located in a cavity of a frame, is hinged on said frame and a bias is provided to cause said unit to pop out of the frame when the closure leaf is open. This is particularly advantageous because it doesn't require external devices since the security system may be fitted within the volume of a conventional frame. It also removes any requirement for complex actuation systems.

In a further subsidiary aspect, said camera operates in conjunction with a wireless transmitter to transmit signals representative of images to a location remote from said unit. This would allow a user to assess danger remotely.

In a further subsidiary aspect, said powered security component is connected to a closure leaf blocker which prevents the door from opening beyond a predetermined partially opened degree and is activated when excessive pressure is applied on said blocker. This configuration is particularly advantageous as it allows filming and spraying for example to be carried out simultaneously with the control of the angle by which a door is opened. In a third broad independent aspect, the invention provides a security system for constraining the opening of a closure leaf such as a door beyond a pre-determined partially opened degree comprising a chassis; means for mounting said chassis, in use, adjacent an opening edge of said closure leaf; an arm which is displaceable from an inoperative position in which it does not block the opening and closing of the closure leaf, into and out of an operative position beyond said chassis in which it does so block the opening of the closure leaf beyond said pre-determined partially opened degree; characterized in that means for mounting said chassis incorporate a plurality of predetermined positions for securing said chassis.

This configuration is particularly advantageous because it allows the closure leaf to open to varying degrees dependent upon the position of the chassis. It allows a door leaf to be secured in a particularly narrow entrance to a building for example.

In a subsidiary aspect, said means for mounting incorporates one or more rails and said chassis is mounted on said rails in order to be placed in a plurality of predetermined positions. The configuration is particularly advantageous because it allows the controlled displacement of the chassis.

In a fourth broad independent aspect, the invention provides a security system for constraining the opening of a closure leaf such as a door beyond a pre-determined partially opened degree comprising a chassis; means for mounting said chassis, in use, adjacent an opening edge of said closure leaf; an arm which is displaceable from an inoperative position in which it does not block the opening and closing of the closure leaf, into and out of an operative position beyond said chassis in which it does so block the opening of the closure leaf beyond said pre-determined partially opened degree; and an actuator which drives the motion of said arm; characterized in that said actuator is a rotor which transmits rotation to said arm via a gear.

This configuration is particularly advantageous because it allows the transmission of rotation from the rotor to be driven without any loss motion mechanism.

In a fifth broad independent aspect, the invention provides a security system for constraining the opening of a closure leaf such as a door beyond a pre-determined partially opened degree comprising a chassis; means for mounting said chassis, in use, adjacent an opening edge of said closure leaf; an arm which is displaceable from an inoperative position in which it does not block the opening and closing of the closure leaf, into and out of an operative position beyond said chassis in which it does so block the opening of the closure leaf beyond said pre-determined partially opened degree; characterized in that said chassis is located at least in part within a hollow portion of a closure leaf frame.

This configuration is particularly advantageous because it allows the security system to be primarily enclosed within existing leaf frame dimensions. It also adds protection to the security system since in order to damage the system an intruder would have to breach the leaf frame.

In a sixth broad independent aspect, a portable security unit comprising a motion sensor, an alarm and activation means; wherein the motion sensor, the alarm and activation means are each housed by the unit.

This configuration is particularly advantageous because it allows the device to be relatively compact in order to be transportable from one monitoring position to another.

In a subsidiary aspect, the unit further comprises means for sounding a message; a bank of messages containing messages in a plurality of languages; and means allowing the user of the unit to select the appropriate language to be used.

This configuration is particularly advantageous because it allows a user to employ the portable security unit in a plurality of geographical locations worldwide.

In a further subsidiary aspect, the unit further comprises a transmitter for transmitting a signal representative of activation to an individual located remotely.

In a further subsidiary aspect, the invention further comprises a camera and/or a microphone for collecting sound and/or pictures and/or video operating in conjunction with a transmitter for transmitting a signal representative of sound and/or pictures and/or video collected by said camera and/or microphone. This allows the user to observe any potential security breach from a distance.

In a seventh broad independent aspect, the invention provides a security system for a closure leaf such as a door or window comprising a unit which pops into sight when the closure leaf is open and which returns to a retracted position as the leaf is closed, characterized in that said unit incorporates a powered security component, which is switched on when the unit is in its popped out position and a linkage member extending between a portion of said security system secured adjacent to said closure leaf and a portion of said security system secured on said closure leaf; wherein when pressure is exerted on said closure leaf beyond a predetermined level a security component is actuated.

This configuration allows the security component to be protected in its retracted mode. It also provides readily operable trigger mechanism without necessarily incorporating motors.

In a subsidiary aspect, said security component incorporates a sprayer. In combination with the features of the seventh aspect, it allows the spray nozzle to be protected from its environment when the door is shut which would avoid any clogging of the nozzle.

In a further subsidiary aspect, said security component incorporates a camera. In combination with the features of the seventh aspect, it allows the lens of the camera to be protected when not in use. It therefore limits any risk of damage which would occur should the camera be exposed in all modes of use.

In a further subsidiary aspect, said unit is located in a cavity of said closure leaf adjacent portion and a bias is provided to cause said unit to pop out of the frame when the closure leaf is open. This configuration is advantageous at least in that it minimises the components required.

In a further subsidiary aspect, said closure leaf adjacent portion houses a canister for a sprayer, one or more batteries and an alarm generator. The combination of alarm and sprayer acts as an improved deterrent. In a further subsidiary aspect, said closure leaf adjacent portion incorporates means for securing said portion to the frame of the closure and said portion which is secured to the closure leaf incorporates means for securing the portion to the closure leaf and a strike plate for operational engagement with said unit; whereby when said closure leaf is closed the strike plate causes the unit to return to a retracted position and when the leaf is opened the strike plate is removed from said unit, whereby said unit is free to pop into sight. This configuration avoids having to place the pop out unit inside the frame of the door and therefore lends itself to retro-fitting to any existing door.

In an eighth broad independent aspect, the invention provides a pressurized canister holder, comprising a housing into which a pressurize canister is placed in use, an aperture allowing the contents of said canister to exit said housing, and a trigger mechanism which acts on said canister to cause its contents to exit through said aperture; wherein said housing incorporates two distinct oppositely located apertures; whereby spraying may be achieved from one of said selected apertures. This allows the holder to be employed for any direction of opening

### BRIEF DESCRIPTION OF THE FIGURES

FIG. 1 shows a front/side perspective view of a security device.

FIG. 2 shows an enlarged perspective view of the upper portion, of a security device.

FIG. 3 shows a horizontal front/side perspective view of the enclosure of a security device incorporating a side plug.

FIG. 4 shows a front perspective view of a security device with the front enclosure removed.

FIG. 5 shows a front/side perspective view of a security device with the front enclosure removed.

FIG. 6 shows an enlarged perspective view of a security device of the lower portion, of the security device.

FIG. 7 shows a rear perspective view of the rear chassis member.

FIG. 8 shows a front view of a security device, security chains and attachment brackets.

FIG. 9 shows a door security system with a portion secured to the doorframe and a portion secured to the door leaf. The view is a perspective schematic view from the outside.

FIG. 10 shows portions of the security system when the door leaf is opened. The view is a perspective view from the inside.

FIG. 11 shows a further view from the outside as a perspective view with the addition of a potential spray zone.

FIG. 12 shows a perspective schematic view of the portions of a security system when the door leaf is shut.

FIG. 13 shows a view of a security device from beneath.

FIG. 14 shows an end section in perspective view of a door security system.

FIG. 15 shows a cross-sectional view through the housing of a door security system.

FIG. 16 shows a cross-sectional view through the gear housing of a door security system

FIG. 17 shows a modification of the preceding embodiment of the invention in plan view.

FIGS. 18A, 18B and 18C show respectively a front elevation of a door when a security system is inactive, a front elevation of a door when a security system is active and a front elevation of a security component in perspective view. FIGS. 19A and 19B show schematic cross-sectional views of a security component respectively in the inactive and the active position.

FIG. 20 shows a security device in schematic cross-sectional view where the security device is located within the frame of a closure leaf such as a door.

FIG. 21 shows an embodiment in the form of a portable security unit in perspective view.

FIG. 22 show a further embodiment of a security system.

FIG. 23 shows a perspective view of an armature, gear housing and motor.

FIG. 24 shows a perspective part cross-sectional view of an armature, gear housing and motor.

FIG. 25 shows a further perspective part cross-sectional view of an armature, gear housing and motor.

FIG. 26 shows a further perspective part cross-sectional view of an armature, gear housing and motor.

### DETAILED DESCRIPTION OF THE FIGURES

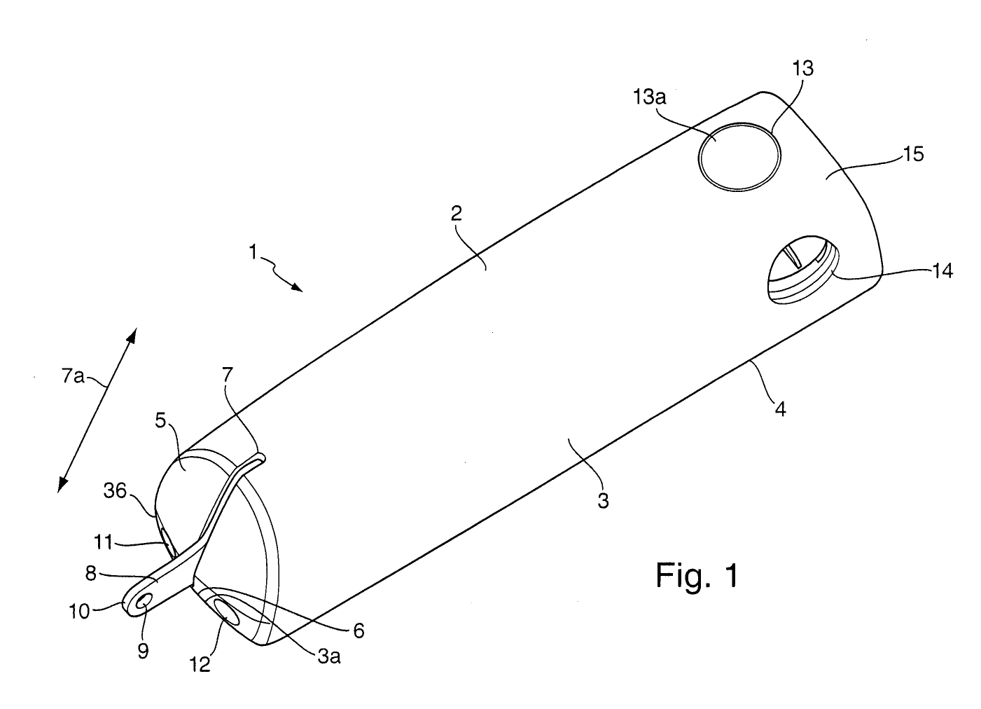

FIG. 1 shows a front/side perspective view of an anti-intruder security device 1, which incorporates a semi-cylindrical, forward facing enclosure 2. Enclosure 2 incorporates substantially vertical outer walls 3 which form a substantially rectangular, rear facing footprint 4. Enclosure 2 also incorporates an inwardly rising, bevelled portion 5, which is located in the enclosure's lower most portion 6. Bevelled portion 5 incorporates a central slot 7, which extends along a substantially vertical plane, indicated by arrow 7a. A Lever member 8 protrudes through central slot 7, extending linearly downwards, from the enclosure's lower most portion 6. The lever member 8 incorporates a circular aperture 9, centrally within the furthermost, radial portion 10 from the enclosure's lower most portion 6. Two circular, countersunk apertures 11 and 12 are located centrally within the enclosure's substantially vertical, lower walls 3a and 3b. Enclosure 2 incorporates two circular apertures 13 and 14, which are located within the enclosure's 2 upper most portion 15. Aperture 13 is located centrally in the front of the enclosure's upper most portion 15. Aperture 13 is shown to be plugged with a circular plug 13a. Aperture 14 is located centrally in the right side of the enclosure's upper most portion 15. Aperture 14 is shown to be located with equal portions residing in the vertical, outer wall 3 and forward facing enclosure 2. An internal audible/spray device 16 is enclosed within the forward facing enclosure 2. The audible and/or liquid spray device 16 is aligned with aperture 14.

The anti-intruder security device 1 is activated when lever 8 is displaced in the direction indicated by arrow 7a. Upon activation, the security device 1 activates the audible and/or liquid spray device 16, which dispenses an audible alarm and/or dispenses a liquid spray through aperture 14. The circular plug 13a may be removed so that the security device 1 may be reconfigured to dispense an audible alarm and/or dispense a liquid spray through aperture 13. The circular plug 13a may then be plugged into aperture 14, when aperture 14 is not in use.

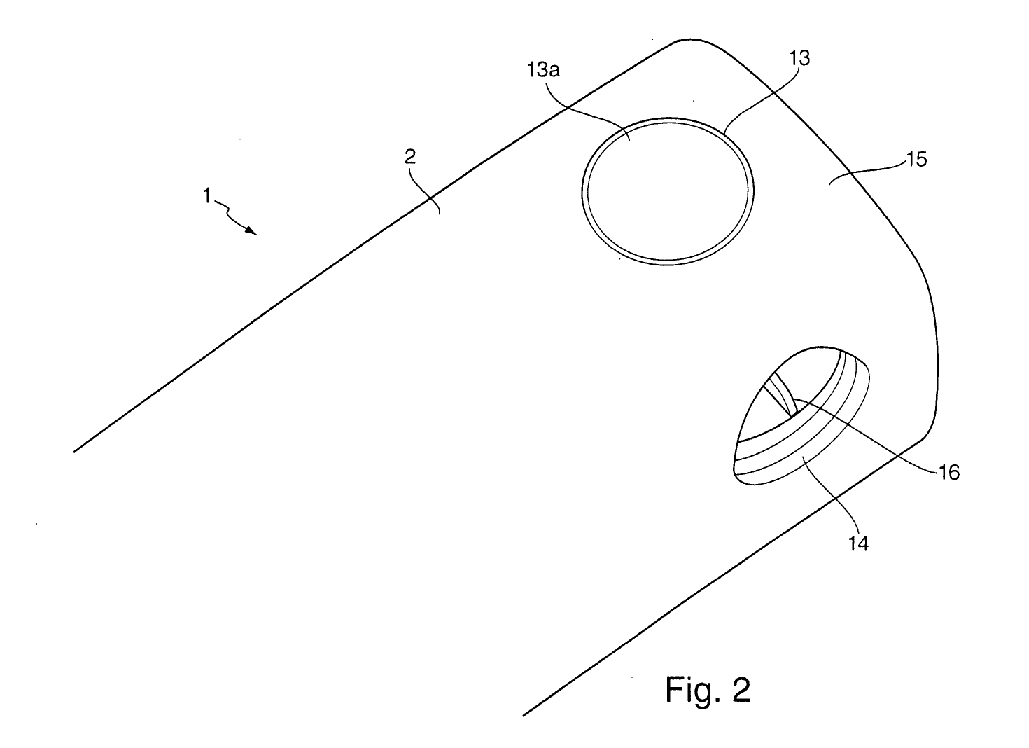

FIG. 2 shows an enlarged perspective view of the anti-intruder security device's 1, semi-cylindrical enclosure's 2, upper most portion 15. The figure clearly shows the locations of circular apertures 13 and 14 within the enclosure's upper most portion 15, the location of circular plug 13a located within aperture 13 and the enclosed audible and/or liquid spray device which is aligned with aperture 14. Apertures such as aperture 14 are located on both sides of the unit to allow operation on either side of a door.

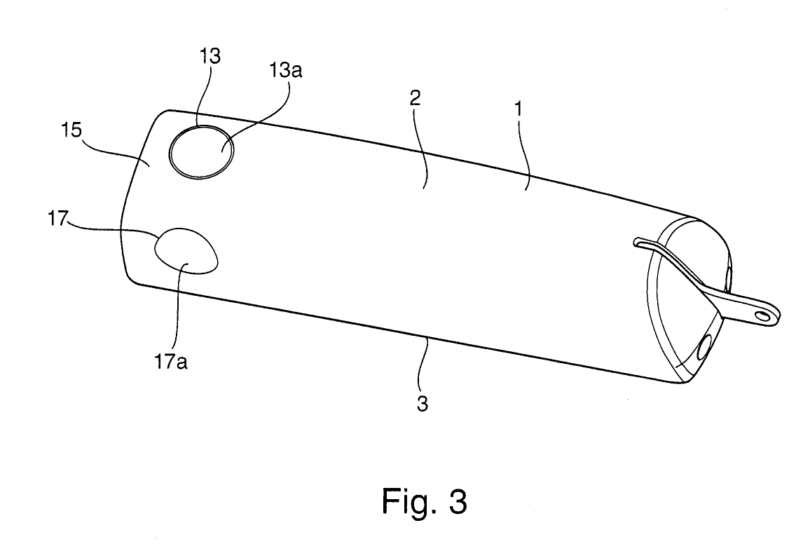

FIG. 3 shows an alternative side perspective view of the anti-intruder security device 1. The figure shows the enclosure's upper most portion 15 with two circular apertures 13 and 17. Aperture 17 is located centrally in the left side of the enclosure's upper most surface 15. Aperture 17 is shown to be located with equal portions residing in the vertical outer wall 3 and forward facing enclosure 2. Apertures 13 and 17 are shown to be plugged with circular plugs 13a and 17a.

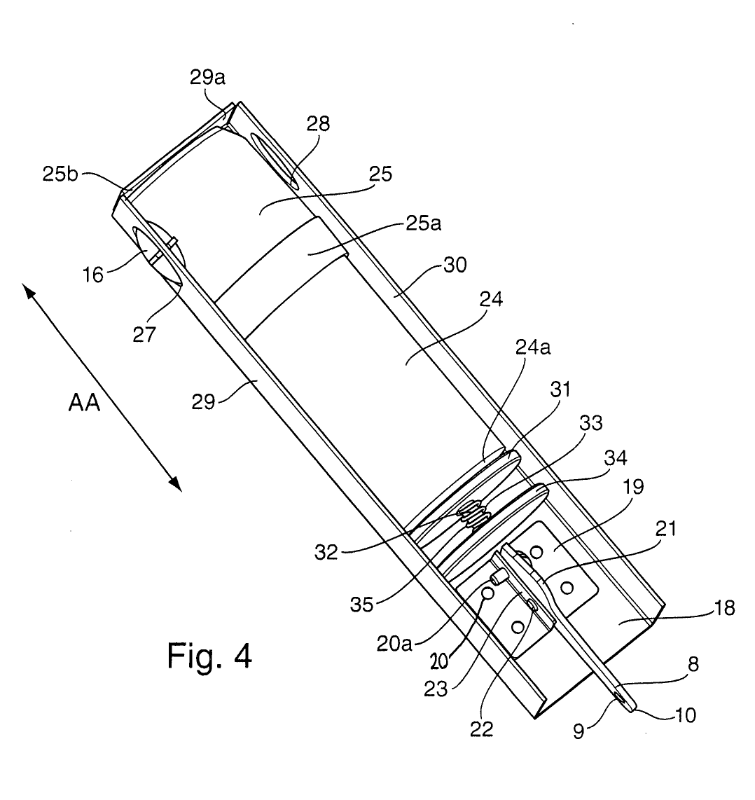

FIG. 4 shows a side perspective view of the Anti-intruder security device 1, with the forward facing enclosure 2 removed (not shown—refer to FIG. 1). The figure shows a rear chassis member 18, which in use, is attached to a vertical surface (not shown) such as the frame of a door or a wall. The chassis member 18 incorporates substantially vertical, outer walls 29, 29a and 30. Outer wall 29 incorporates a circular aperture 27 within its upper portion. Outer wall 30 incorporates a circular aperture 28 within its upper portion, which mirrors aperture 27. The audible/spray device 16 is located within the rear chassis member 18. The audible/spray device 16 is also aligned with side aperture 27.

The audible/spray device 16 comprises an upper cylindrical cap 25, which incorporates a flat horizontal uppermost surface 25b, and a main cylindrical body 24. The main cylindrical body 24 incorporates a cylindrical, bevelled surface 24. The cylindrical cap 25 is vertically displaceable along axis AA. The cylindrical cap 25 incorporates a cylindrical portion 25a, which overlaps the main cylindrical body 24. The cylindrical cap portion 25 is permanently attached to main cylindrical body 24. The main cylindrical body 24 abuts the upper surface of circular disc 31. Circular disc 31 incorporates a central boss 32, which is perpendicular to the disc's lower surface. A helical spring 33 is mounted upon central boss 32, the opposite end of the spring. The canister 24 is abutting a circular disc portion 31 against its lower face. The circular disc 31 incorporates a boss 32, which is centrally mounted within the circular disc 31. The boss 32 is located within a helical spring 33. The opposite end of the spring 33 is mounted upon boss 35. Boss 35 is mounted centrally upon the upper surface of circular disc portion 34. Circular disc portions 31 and 34 are located centrally within the rear chassis member 18, and vertically aligned along axis AA. The projecting lever member 8 is permanently attached to the rear chassis member 18, via hinge portion 20a within a rectangular fixing bracket 19. Lever arm member 8 extends linearly downwards, from the rear chassis lowest edge. The lever arm member 8 also incorporates a protruding cam portion 21 in its upper portion. The lever arm member incorporates a circular aperture 9, centrally within the furthermost, radial portion 10. The fixing bracket 19 is permanently attached to the rear chassis member 18, via four circular fixing points 20. The fixing bracket 19 is centrally mounted within the lower portion of the rear chassis member 18. The fixing bracket 19 incorporates two vertical flanges 23, which are vertically and centrally mounted along axis AA. The two vertical flanges 23 incorporate the hinge portion 20a located in its upper, vertical portion. The vertical flanges 23 also incorporate a retaining shear pin 22 located in its lower, vertical portion. The anti-intruder device 1 is activated by chain (not shown) which is attached to the lever arm member 8, via circular aperture 9. The chain pulls the lever arm 8 in a forward and upwards direction, which applies pressure to retaining shear pin 22. At a given pressure, the retaining shear pin 22 will shear, allowing the lever arm member 8 to continue until it has reached the end of its forward and upwards travel. As the lever arm member 8 travels forward and upwards, it rotates about hinged portion 20a. During this rotation, protruding cam portion 21 engages the lower surface of circular disc portion 34. The outer, vertical profile of cam portion 21 displaces circular disc portion 34 in a vertically upwards direction, when lever arm member 8 is rotated about hinged portion 20a. As circular disc portion 34 is displaced vertically upwards, it applies vertically upward pressure onto helical spring 33, which in turn applies vertical upwards pressure to circular disc portion 31. Therefore, as circular disc portion is displaced vertically upwards, it engages the cylindrical body 24 of the audible/spray device 16. The cylindrical body 24 is displaced vertically upwards, and into a cylindrical cap portion 25. The displacement of the cylindrical body 24 into a cylindrical cap is contained within cylindrical portion 25a. As cylindrical body 24 is displaced vertically upwards, it applies vertical pressure onto cylindrical cap 25, which in turn engages the cylindrical cap's flat top surface 25b against the inner surface of outer wall 29a. As the vertical pressure increases, the cylindrical body 24 is displaced into the cylindrical cap 25, which opens a valve (not shown) within the cylindrical cap for activating the audible/spray device 16. Activation of the audible/spray device 16 results with the sounding of an audible alarm and/or jettisoning of a security liquid from the device 16, in the direction of the intruder, via aperture 27 and aperture (14—see FIG. 1) within the front semi-cylindrical enclosure.

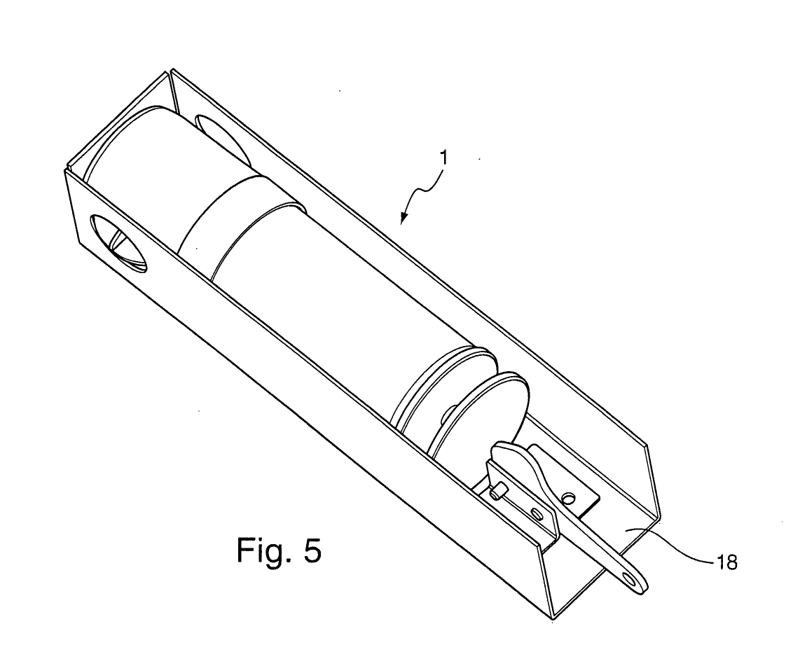

FIG. 5 shows an alternative side perspective view of the anti-intruder security device 1. The figure is identical to FIG. 4, but with an increased side perspective view of the rear chassis 18 and all of the device's components contained therein.

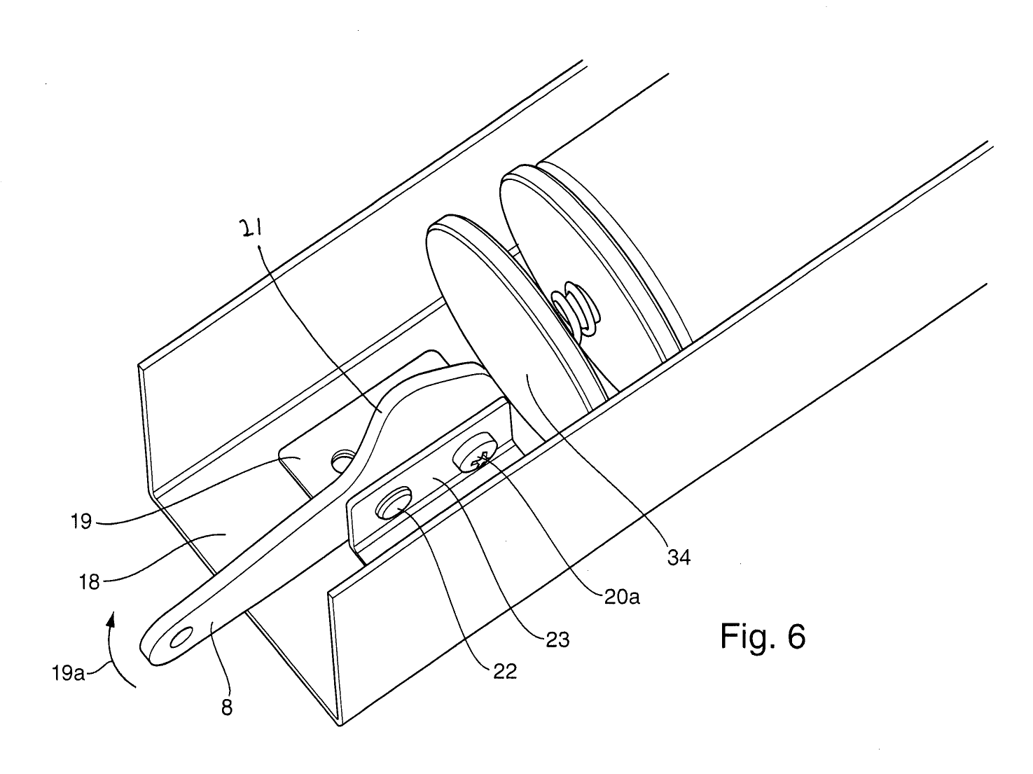

FIG. 6 shows an enlarged side perspective view of the lower portion of the rear chassis 18. The figure shows the lever member 8 attached to fixing bracket 19, via hinge portion 20a. Both the hinge portion 20a and the retaining shear pin 22 are located with two vertical flanges 23. The profile of the protruding cam portion 21, details how the cam portion 21 applies vertically upward pressure onto circular disc portion 34, to activate the audible/spray device 16, when the lever arm member 8 is rotated about hinged portion 20a in the direction indicated by arrow 19a.

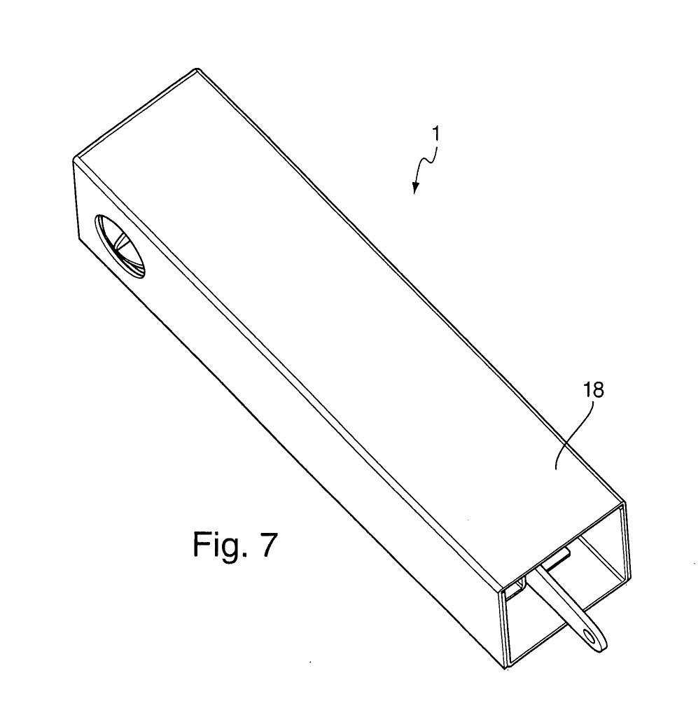

FIG. 7 shows a rear perspective view of the anti-intruder security device 1. The figure shows the rear foot print of rear chassis 18, which engages with a wall or vertical surface.

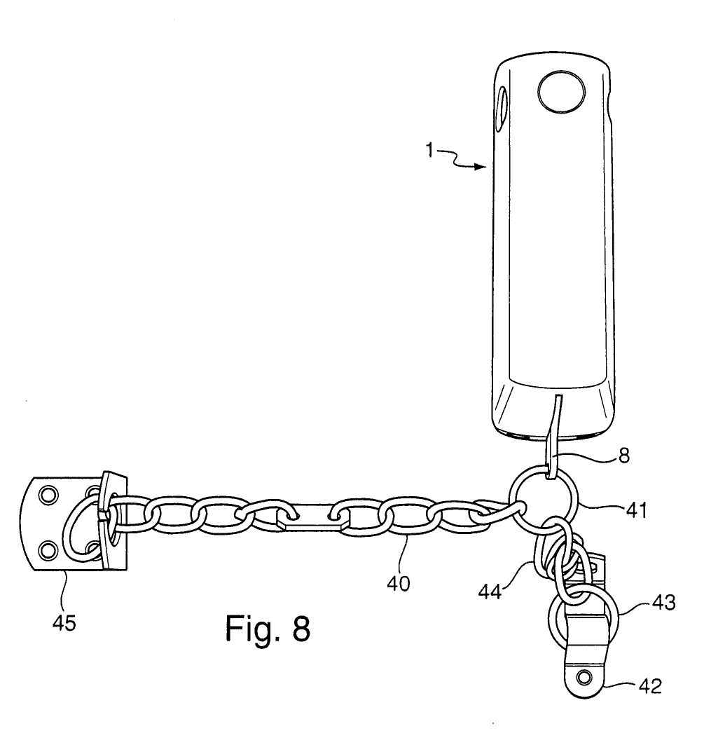

FIG. 8 shows a front perspective view of the anti-intruder device 1 with its security chain links 40 and 44. Both security chains are permanently attached to metallic ring 41, which is permanently attached through lever arm member 8. Fixing bracket 45 is used to attach security chain 40 to a door from the security device 1 via metallic ring 41. Fixing bracket 42 is used to attach security chain 44 to a vertical internal surface, from the security device 1 via metallic ring 41.

The security device is located adjacently to a door via a door frame or on a wall. The security device may in a particularly advantageous configuration be located on a vehicle (road going, sea going and/or air going vehicle) such as the rear door of a van. The protruding member 8 incorporates a ring upon which is located a chain which is connected to a fixing bracket on a releasable fixing bracket mounted on a wall, also attached to this chain is a secondary chain which is linked to an anchor point below the security device on the door frame or wall. The security device is located so that the current nozzle 26 is either facing to the side with the intention of spraying and sounding the audible alarm in the direction of the intruder as they come through the door or the nozzle is in a front facing direction to engage the fluid/audible alarm to the intruder in a front facing direction as they approach the door.

As the door is pulled or yanked the fixing pin will not break till a substantial exertion has been applied therefore showing intent to enter the doorway this fractures the retaining pin which then allows the protruding member to raise in an upper direction which enables the cam portion to engage the bottom disc which then compresses the spring and which lifts the second disc which engages the canisters bottom surface which then pushes the canister in an upwards direction therefore engaging the canister cap to the top inside surface of the enclosure which therefore activates the security canister and an audible/fluid alarm is ejected towards the direction of the intruder. In an alternative embodiment of this invention the canister may be replaced with an electronic subassembly which contains a contained power supply or a mains power supply which incorporates a pad/disc which engages with the lever as described in the previous invention but instead of a cam it activates electronic circuitry components to sound alarms or give off some kind of detection alarm signal as well as jettison a cartridge type fluid based marker in the direction of the would be intruder.

Items have been developed for specific use within the invention, one of which being a chemical release mechanism that when activated by way of an attempt to gain entry through the front door with the use of force automatically marks a potential intruder with a trace liquid.

This trace liquid is a clear non-toxic, UV based substance which is only visible under ultra-violet light that has a unique DNA code traceable to a given canister. When presented to clothes or skin can remain for weeks even following exfoliation and the washing of clothes. In the event of an arrest being made and the individual is found to be stained with this substance the relevant authorities are able to analyse the stain and can determine the exact location where this security device was installed and registered, clearly placing that individual at the scene of a specific crime and at the same time increasing detection rates.

### Sequence:

1: Chassis to incorporate Chemical Can and 138-decibel screech alarm, this is then secured to the frame very close to the door.

2: The Security Chain is put in place prior to opening the front/rear door this connects from a secured mount within the box from the frame to the retaining device fitted on the door.

3: The chain is attached to a dual feature trigger mechanism fitted to the underside of the secured box, if the door is pushed with exerted force a retention pin will break, thus pulling the trigger mechanism, the sounder will sound and the dual alarm feature when capacity is reached will spray the UV & DNA trace liquid. The canisters are adapted to be emptied on the perpetrator in one action and cannot be used again. This meaning any person carrying that specific code will either be a party to, or a perpetrator of a specific crime.

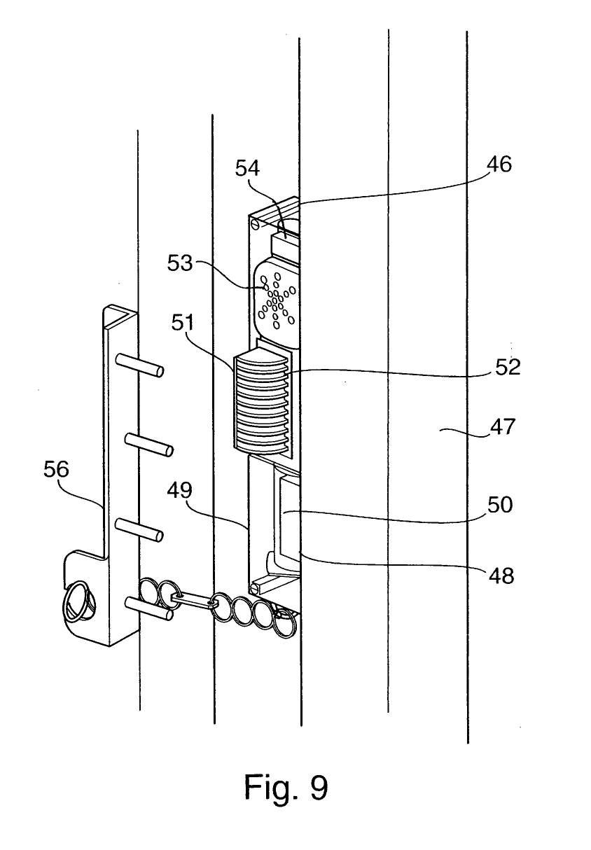

FIG. 9 shows a security system when fitted to a closure leaf such as a door or window. Portion 46 of the security system is secured to the doorframe 47 by a plate 48 incorporating a number of apertures through which a number of releasable attachment means such as screws are provided. Once this plate is secured to the doorframe, housing 49 is secured to the plate. Inside housing 49, a canister 50 is provided which may incorporate pressurised chemicals which may be selected from the following group: tear gas, liquids with uniquely identifiable DNA strands and/or dyes. A pop-out unit 51 incorporates a wedge shaped portion with a plurality of closely contiguous apertures such as aperture 52. When pressurised fluid is allowed to flow through these apertures, a spray is achieved. The pop-out unit is caused to be in the position shown by a bias. Circuitry is provided within the housing in order to cause the security system to be armed when the pop-out unit is in its popped-out position.

The housing also incorporates a plurality of apertures in its front face such as aperture 53. These apertures extend in a number of lines in radial directions from a centre point. In close proximity to said apertures and within the housing, there is provided an alarm generator such as a sounder 54 which may cause a panic alarm to sound. The panic alarm may be triggered by an operator pressing a panic button 55 as shown in FIG. 2 or simply because the security system detects an abnormal pressure being exerted on the door so that an alarm is sounded. The alarm may take several forms. It may for example be a personalised recording or a noise.

Figure TO shows the pop-out unit in its popped-out position as well. FIG. 2 shows a portion 56 which is secured to the door leaf itself by employing a number of screws such as screw 57. Portion 56 incorporates a flat base portion 58 with two projections 59 and 60. Projection 59 acts as a strike panel against which pop-out unit 51 engages when the door leaf is closed. The strike panel ensures that the pop-out unit remains inside the security system's housing when the door leaf is shut. Projection 60 incorporates an aperture 61 with a side opening 62 through which a chain may be threaded. A chain 63 is provided between portion 56 which is secured to the door leaf and portion 46 which is secured to the door leaf frame. The door chain acts as a trigger for the security system. If a pressure is applied to the door leaf which exceeds a predetermined threshold, then either the alarm generator 9 sounds or the pop-out unit sprays. The invention also envisages replacing the sprayer by a camera. Alternatively, the unit may also incorporate both a sprayer and a camera located in the same pop-out unit or located in two separate pop-out units.

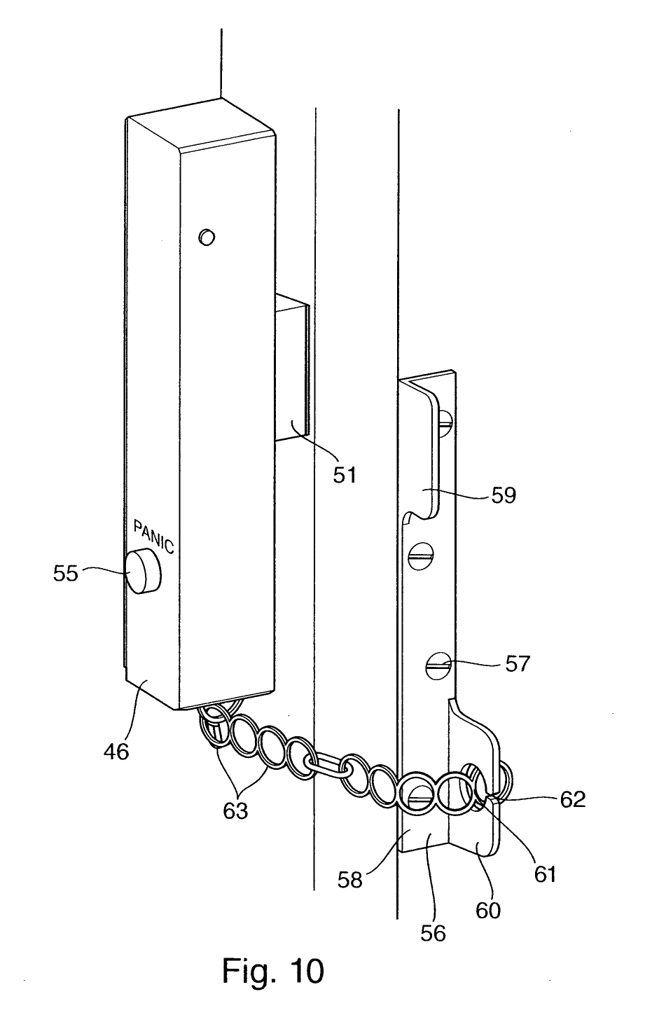

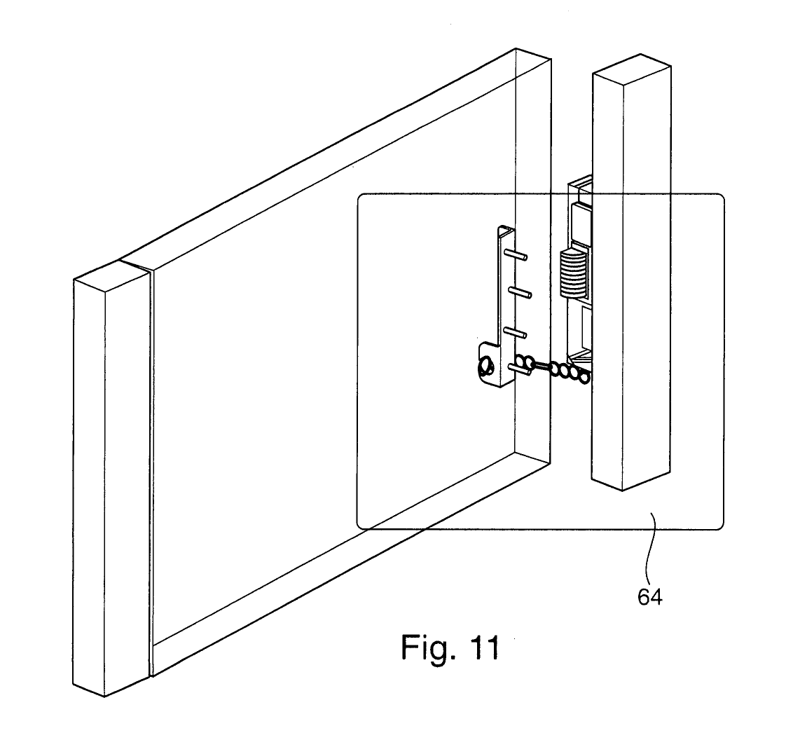

FIG. 11 shows the same security unit embodiment as shown in FIGS. 9 and 10 with the addition of a potential spraying zone 64.

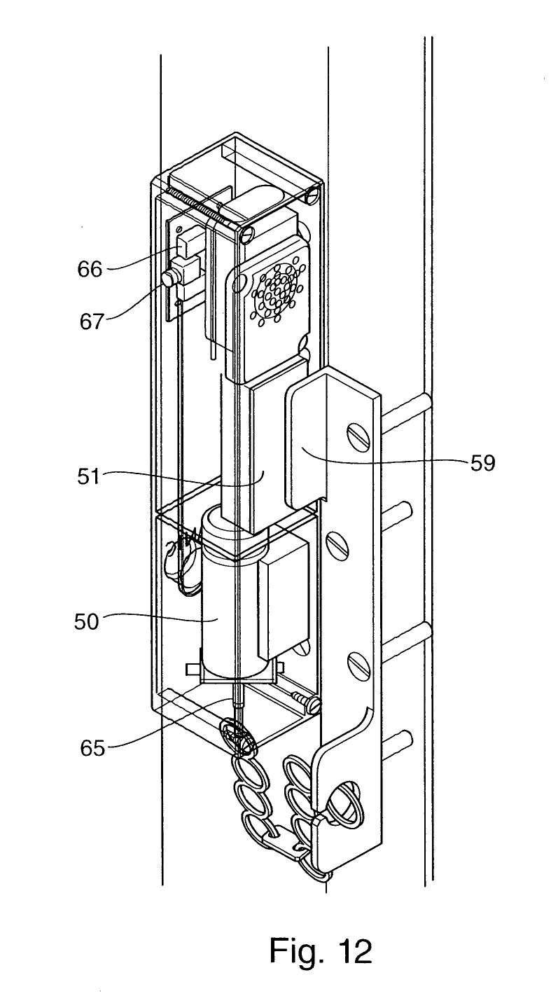

FIG. 12 shows the pop-out unit 51 in its retracted position as the strike plate 59 causes it to retain within the cavity provided within the housing. Canister 50 incorporates a button or valve 65 which when drawn downwards causes pressurized fluids to be channeled to the sprayer. A safety mechanism may be provided so that when the pop-out unit 51 is in its retracted position no pressurized fluid can exit from the unit. A battery 66 may be provided to cause the sounder to sound an alarm when either the panic button is pressed or an excessive pressure is applied on the door leaf.

An operational indicating means 67 in the form of a light emitting diode is also provided so that a user may check whether the system is armed.

The portion of the security system which is fixed to the door frame or to an adjacent structural portion may also be incorporated inside the door frame itself. In this configuration, the edge of the door itself would act as the strike panel and the triggering of the mechanism would be achieved by an appropriate means for sensing forced entry. This appropriate means may be for example, incorporated into a chainless door blocker such as illustrated in published patent application WO 03/038380 or WO 00/73609.

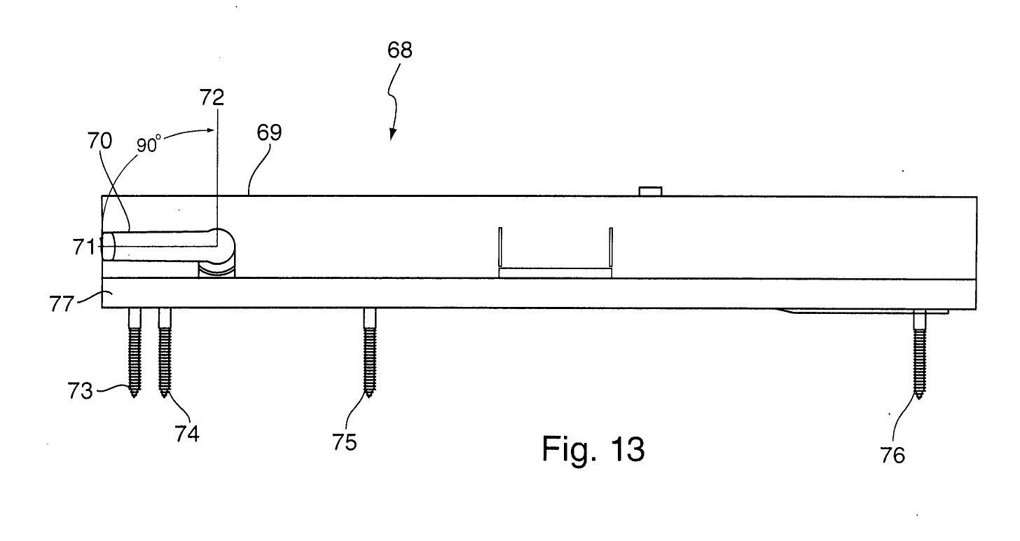

FIG. 13 shows a security system generally referenced 68 which is particularly suited for being fitted neighbouring a closure leaf such as a door or window. The security system incorporates a housing 69 for the electronic and mechanical components. The housing may be made of steel or any other similarly appropriate material which resists bending. Protruding from housing 69 there is provided an arm 70 which is rotatable as indicated by the figure between position 71 and 72. In position 71, the arm is in its inoperative position in which it does not block the opening and closing of the closure leaf. In position 72, the arm is in its operative position in which it allows the door to be opened to a pre-determined partially opened degree. A rotor located within the housing drives the motion from position 71 to position 72 and from position 72 to position 71. A number of bolts such as bolts 73, 74, 75 and 76 are provided at regular intervals along the base portion 77 in order to secure the security system to a wall portion in the vicinity of a door frame.

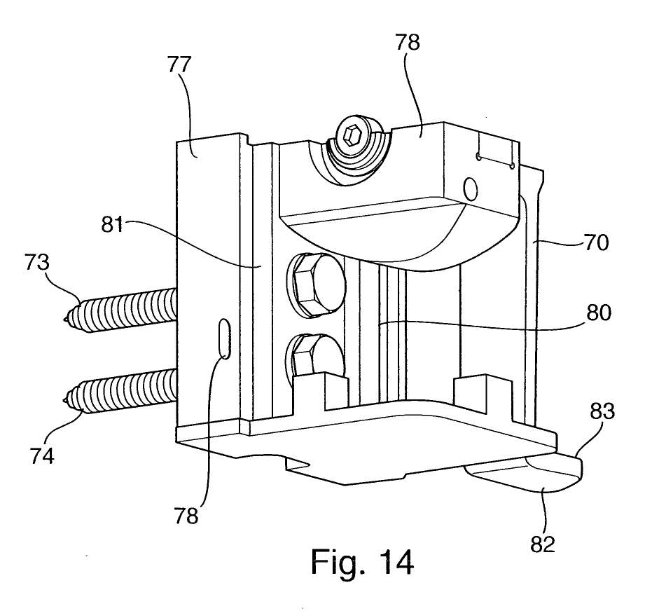

FIG. 14 shows bolts 73 and 74 in greater detail as well as the inside portion of the end of a security system. The cover of the housing clips into recess 78 provided on base 77. A gear housing 79 transmits the rotation of the shaft of a rotor to the arm 70. The gear housing 79 is shaped and configured to attach to rails 80 and 81 provided in the base portion 77 of the security system. This allows the arm to be placed at various locations along the base in order to be able to suit a variety of doors and entrances to buildings for example. The arm 70 is shown as substantially L shaped with convex inner and outer faces 82 and 83.

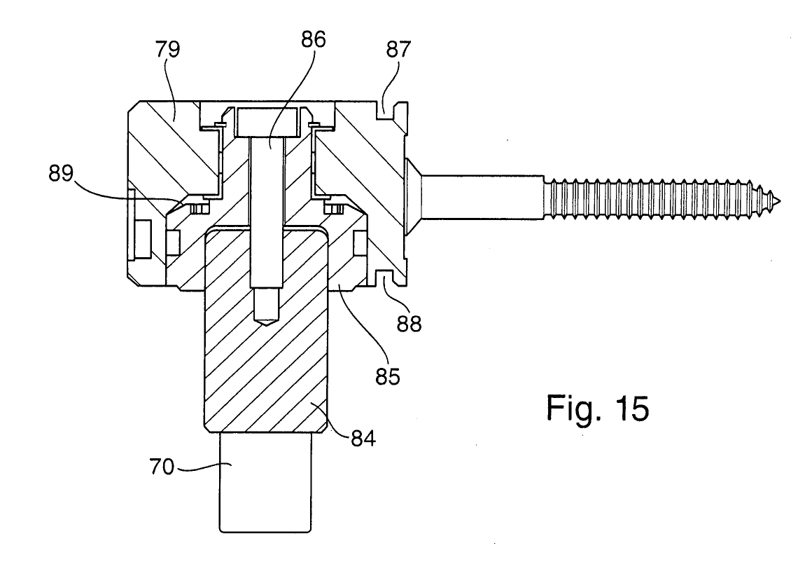

FIG. 15 shows arm 70 and gear housing 79 in greater detail. Arm 70 is connected to gear housing 79 via an integral mounting block 84 to the moveable portion of the gear 85. The moveable portion 85 is secured to mounting block 84 via a screw 86. Gear housing 79 incorporates two troughs 87 and 88 which correspond to rails 80 and 81 located on the base of the security system. Appropriately sized teeth (not shown) of the rotor shaft engage appropriately sized teeth 89 of the moveable portion.

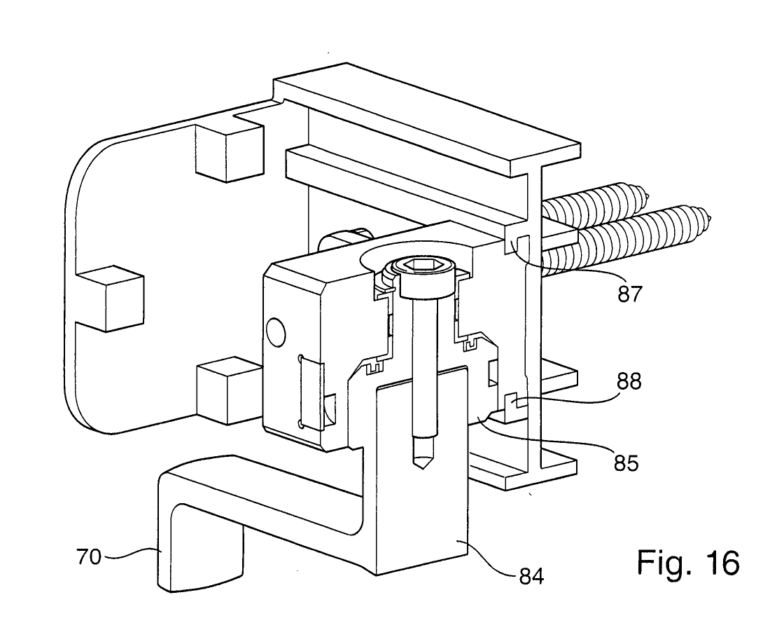

FIG. 16 shows the previously described components of FIG. 15 in greater detail. In this embodiment mounting block 84 and arm 70 are integrally formed.

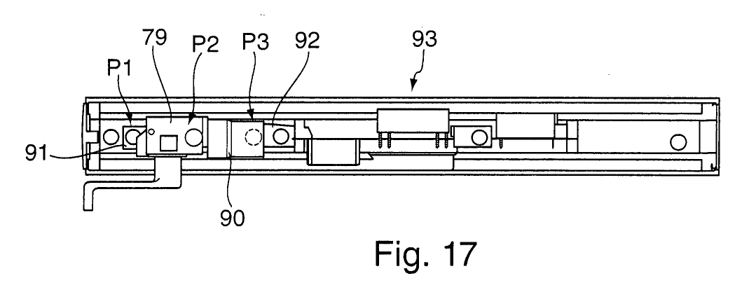

FIG. 17 shows the rotor 90 engaging the gear housing 79. The combination of gear housing and rotor are secured not only via the troughs and rails described previously but also via extension portions 91 and 92 which allow bolts to be located. This configuration allows the combination of gear housing and rotor to be secured independently from the rest of the housing. Other components of the security system are shown such as the necessary control circuitry generally referenced 93. In this embodiment, a number of holes through the base of the security system are envisaged whereby the combination of gear housing and rotor can be placed and secured to the base at a variety of positions Pi, ?z and P3

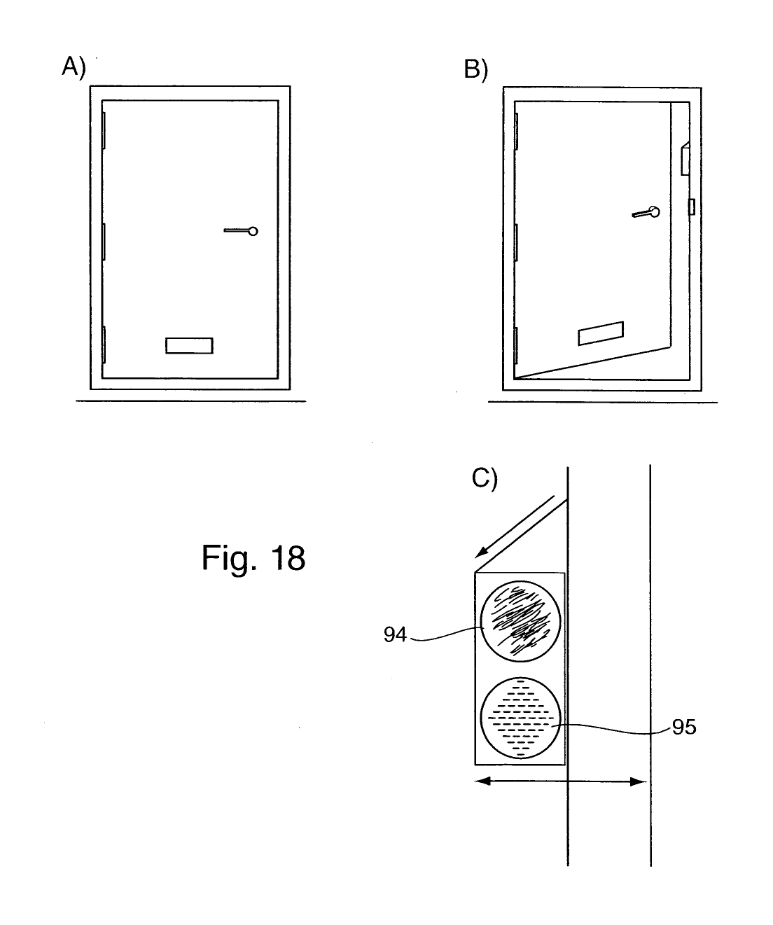

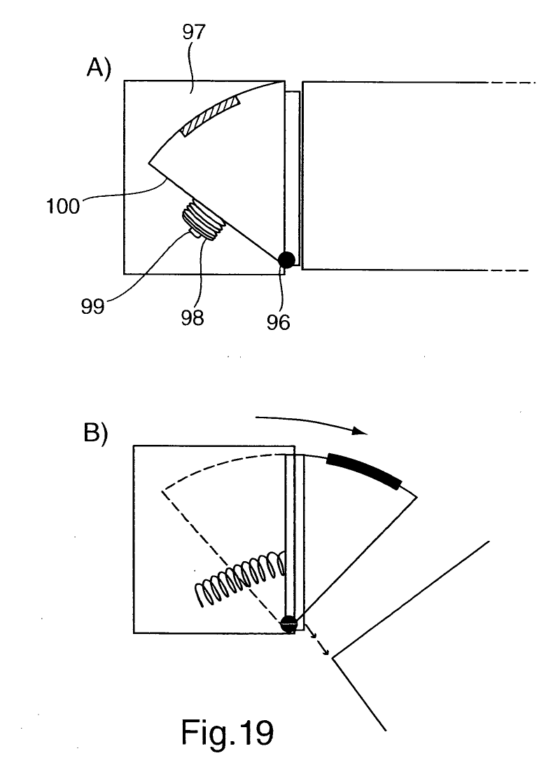

FIG. 18A shows a door where the security system would be in its inactive position. FIG. 18B shows a door which has been marginally opened and in which a security component pops out of the frame into sight. The security component may incorporate a battery to allow it to be self sufficient. Alternatively, it may be wired through the frame of the door. In this embodiment it comprises a camera or a mini-camera 94 located next to a sprayer 95.

As can be seen in FIG. 19, the security component is substantially triangular in cross-section. The component is hinged by hinge 96 and located in a hollow portion 97 of a door frame. A spring 98 is located between an abutment 99 and face 100 of the security component. As the door is opened, the compression in the spring causes the component to exit from the door frame in order to expose the camera and sprayer as shown in FIG. 19B. As the door is shut the door engages the narrow portion of the triangle and forces the security component back into the hollow space provided in the door frame. The electronics of the system are set to cause the security component to be active only when it is in its popped out position in which the camera records pictures and/or videos of the scene in front of the front door. If an unauthorized access attempt is made, a sensor is activated and chemical produce is fired out of the sprayer.

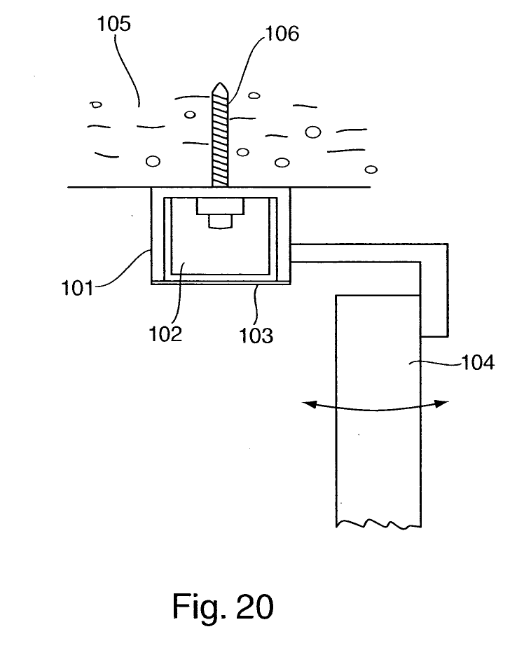

FIG. 20 shows a U shaped door frame 101 and a security device 102 located within the door frame. The frame is sealed in a conventional manner with a plate 103 extending around the periphery of the door. The security device 102 incorporates an arm which may be displaced into and out of a pre-determined door blocking position in order to prevent door 104 from being opened beyond this blocked position. In this embodiment the security system is also protected by the door frame itself. Both the door frame and the security system may be simultaneously secured to a neighbouring wall 105 via a bolt 106.

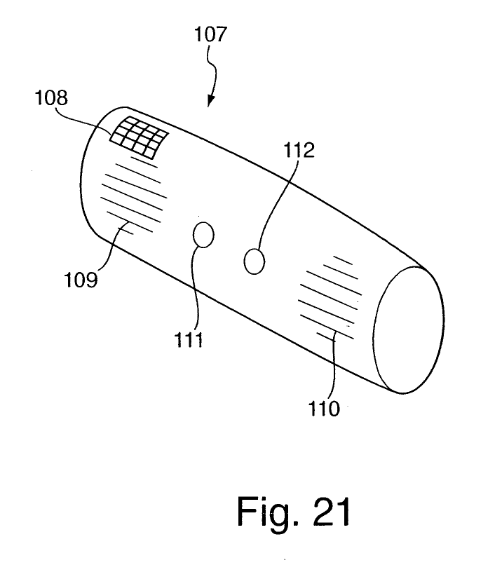

FIG. 21 shows a portable security unit 107 with a touch pad 108 activating and deactivating the unit. It incorporates a number of loud speakers 109 and 110 which can have the dual function of emitting sound and/or an alarm signal. The sound may be produced by any appropriate audio device such as a radio receiver. The security unit incorporates a motion sensor 111 which may be a mercury/impact switch or a sonic bubble which may be aimed, aligned or placed towards the hotel, apartment, caravan, tent, entrance and may be set by the control pad by entering a 4-digit code which would set a pre-determined time period before the system would be armed. The time delay may be for example 10 to 20 seconds. In addition to the motion sensor the unit may incorporate a smoke/carbon monoxide detector 112 to sound the alarm if a pre-determined level of smoke and/or carbon monoxide is breached. The device may also incorporate a sprayer and alarm combination which would be triggered by motion.

Instead or as well as the motion sensor a camera such as a mini camera may be fitted. It is preferred that the mini camera has a night vision capability. The camera would also preferably be operated by a motion sensor which could be aimed at a door. A small screen on top of the unit may be employed for alignment.

When activated by motion, the camera will record for a length of time. The audible warning may be in the form of initially the words “alarm activated” which would provide the potential intruder with sufficient time to think again and leave. The unit would preferably incorporate translation software so that any statement produced by the alarm system could be in the language of the country being visited at the time.

If movement continues or a shock sensor is triggered, the alarm would be set to sound. The battery contained within the unit would allow the alarm to sound until it is deactivated by entering a four-digit code.

The system may also incorporate text-pictures/video messaging facilities in order to transmit a message to an occupier/user that the alarm has been activated in order to allow him/her to take appropriate action.

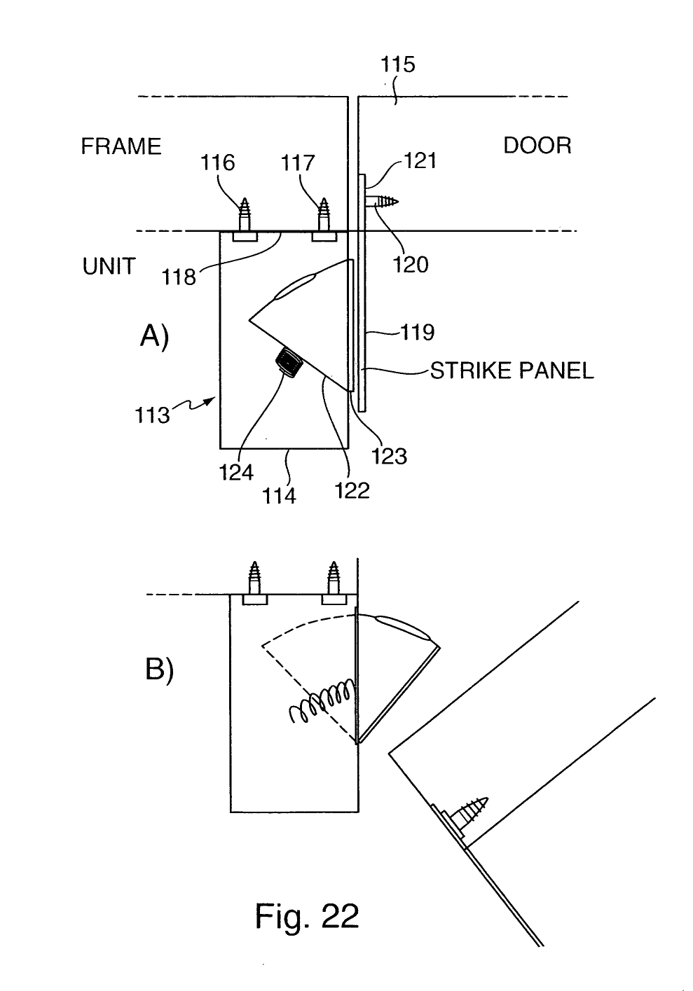

Furthermore, the system may transmit a picture and video so that if the person identified by the camera of the unit is no intruder then the unit may be controlled remotely to switch off. A wireless transmitting and receiving facility would therefore be incorporated within the unit. FIG. 22 show a stand-alone security unit 113 which incorporates a housing 114 which may be secured to an existing door frame or a replacement door frame or to the wall adjacent to door leaf 115 by employing one or more screws such as screws 116 and 117. Appropriate projecting portions 118 are provided with a number of recesses to accommodate these screws. A strike panel 119 in the form of a plate which is attached to door 1 15 via one or more screws 120 which pass through appropriately sized holes 121.

The mechanism of this stand-alone security unit is similar to the mechanism described in previous figures. Within housing 114 there is provided a security component 122 which is hinged at one corner 123 and biased to tend to protrude from an opening in the housing by a spring 124. The spring 124 causes the security component 122 to pop out of housing 114 when the door and its strike panel are removed when it is opened. This configuration is shown in FIG. 22b. When the security component pops out it reveals either a camera or a sprayer or both. In this stand-alone version the housing 114 may incorporate batteries for driving the function of the camera and sprayer.

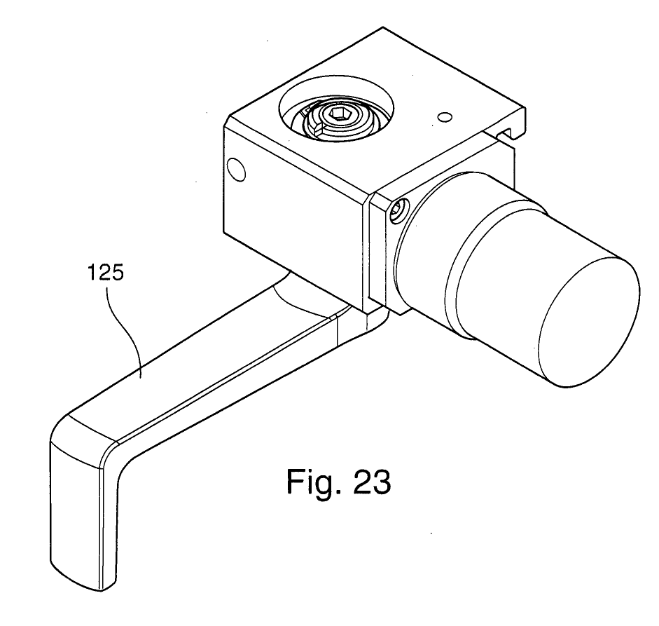

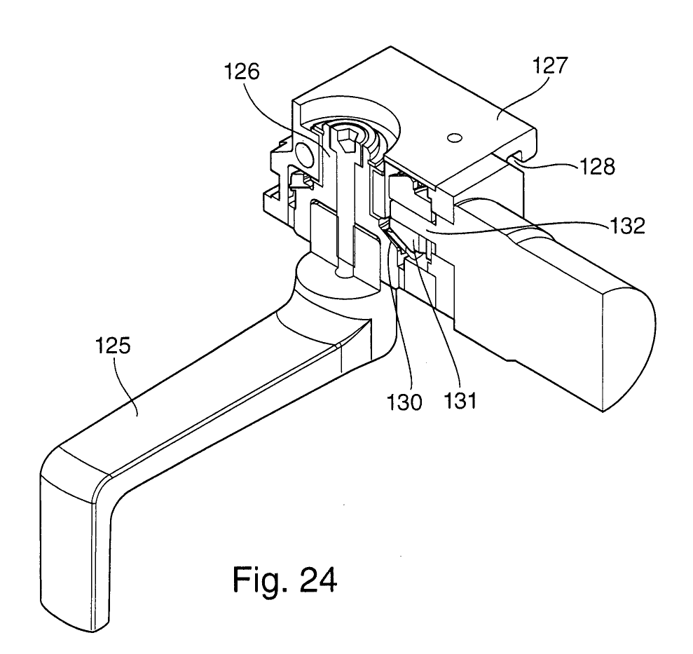

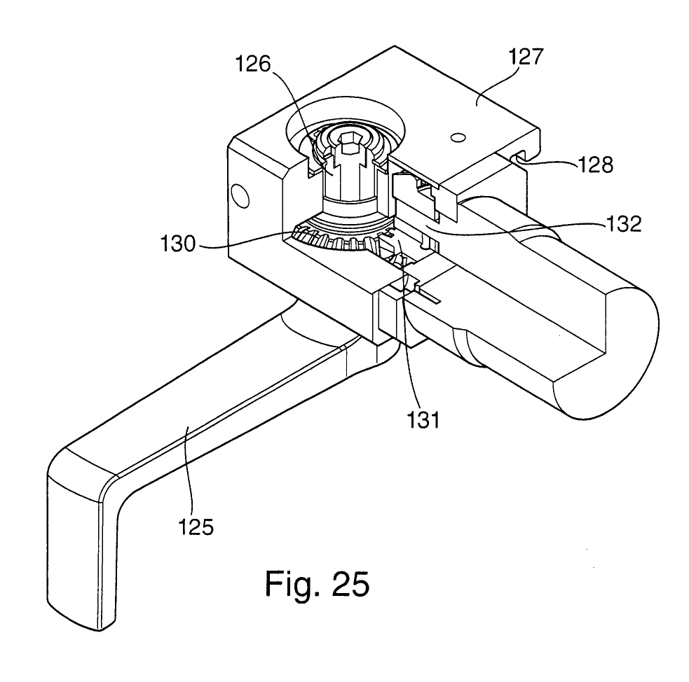

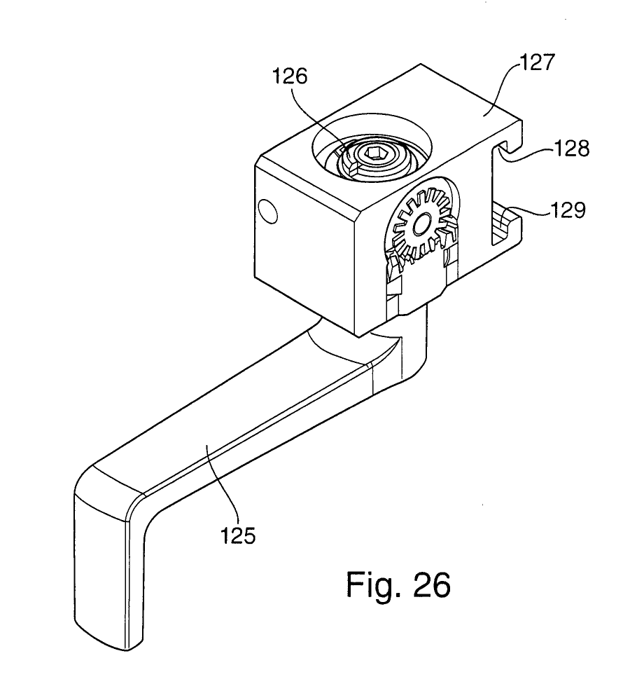

FIGS. 23, 24, 25, and 26 show an arm 125 attached via shaft 126 to a housing 127 which may be secured via trough 128 onto a corresponding rail of a chassis. A further trough 129 (FIG. 26) located on the opposite side of the housing 127 is provided for securing the housing to the rail or guide (not shown). Shaft 126 incorporates a tapered portion 130 with gear teeth for engagement with corresponding gear teeth provided on a further shaft 131 with a tapered portion. Shaft 131 engages with the rotor shaft 132. The gears allow the axes of rotation of the shafts to be at 90 degrees from one another in order to improve the compactness of the system.

1-33. (canceled)

34. A security device for a closure leaf comprising:
a link member extending between a portion of said security device located on said closure leaf to which said link member is attached, in use, and a portion of said security device located adjacent to said closure leaf to which said link member is attached, in use; whereby said link member restrains the opening of said closure leaf beyond a predetermined degree;
a canister of pressurized substance;
a canister holder for securing said canister on a support structure; whereby said canister is in a position for spraying a subject in the vicinity of said closure leaf; and
an actuator which engages said link member and which applies pressure to said canister when pressure is exerted on said closure leaf beyond a predetermined level; whereby said canister sprays.

35. The security device according to claim 34, wherein said actuator incorporates a lever which is pivotally mounted to said canister holder and which engages said link member; whereby when said link member is in sufficient tension said lever causes said canister to spray.

36. The security device according to claim 35, wherein said lever incorporates a restraining component which is breakable only when a predetermined pressure level is breached.

37. The security device according to claim 36, further comprising a mount to which the lever is mounted and said restraining component is a shearable pin extending through said lever and its mount.

38. The security device according to claim 34, wherein said security device further incorporates an audible alarm.

39. The security device according to claim 35, wherein said lever incorporates a cam portion which engages and lifts said canister against said holder in order to activate it.

40. The security device according to claim 35, wherein said actuator further comprises a disc member located underneath said canister against which a lever applies pressure in use.

41. The security device according to claim 40, wherein at least two disc members are connected together via at least one spring member.

42. The security device according to claim 34, wherein said canister incorporates a button for triggering the spraying located at the upper portion of the canister and a spraying duct located laterally; said device further comprising a housing which acts as a canister holder and which incorporates at least one side aperture corresponding to the spraying duct of said canister.

43. The security device according to claim 42, wherein said housing incorporates two side apertures located on opposite sides of said housing.

44. The security device according to claim 34, wherein said actuator incorporates electrical or electronic circuitry which activates one of an audible alarm and a liquid sprayer.

45. A security system for a closure leaf comprising:
a unit which pops into sight when the closure leaf is open and which returns to a retracted position as the leaf is closed
wherein said unit incorporates a powered security component which is switched on when the unit is in its popped out position.

46. The security system according to claim 45, wherein said security component is a camera.

47. The security system according to claim 45, wherein said security component is a sprayer.

48. The security system according to claim 45, wherein said unit is located in a cavity of a frame, is hinged on said frame and a bias is provided to cause said unit to pop out of the frame when the closure leaf is open.

49. The security system according to claim 46, wherein said camera operates in conjunction with a wireless transmitter to transmit signals representative of images to a location remote from said unit.

50. The security system according to claim 45, wherein said powered security component is connected to a closure leaf blocker which prevents the door from opening beyond a predetermined partially opened degree and is activated when excessive pressure is applied on said blocker.

51. A security system for constraining the opening of a closure leaf beyond a pre-determined partially opened degree comprising:
a chassis;
means for mounting said chassis, in use, adjacent an opening edge of said closure leaf;
an arm which is displaceable from an inoperative position in which it does not block the opening and closing of the closure leaf, into and out of an operative position beyond said chassis in which it does so block the opening of the closure leaf beyond said pre-determined partially opened degree;
wherein the means for mounting said chassis incorporate a plurality of predetermined positions for securing said chassis.

52. The security system according to claim 51, wherein said means for mounting incorporates at least one rail and said chassis is mounted on said rail in order to be placed in a plurality of predetermined positions.

53. A security system for constraining the opening of a closure leaf beyond a pre-determined partially opened degree comprising:
a chassis; means for mounting said chassis, in use, adjacent an opening edge of said closure leaf;
an arm which is displaceable from an inoperative position in which it does not block the opening and closing of the closure leaf, into and out of an operative position beyond said chassis in which it does so block the opening of the closure leaf beyond said pre-determined partially opened degree; and
an actuator which drives the motion of said arm;
wherein said actuator is a rotor which transmits rotation to said arm via a gear.

54. A security system for constraining the opening of a closure leaf beyond a pre-determined partially opened degree comprising:
a chassis;
means for mounting said chassis, in use, adjacent an opening edge of said closure leaf;
an arm which is displaceable from an inoperative position in which it does not block the opening and closing of the closure leaf, into and out of an operative position beyond said chassis in which it does so block the opening of the closure leaf beyond said pre-determined partially opened degree;
wherein said chassis is located at least in part within a hollow portion of a closure leaf frame.

55. A portable security unit comprising a motion sensor, an alarm and activation means; wherein the motion sensor, the alarm and activation means are each housed by the unit.

56. The portable security unit according to claim 55, further comprising means for sounding a message; a bank of messages containing messages in a plurality of languages; and
means allowing the user of the unit to select the appropriate language to be used.

57. The portable security unit according to claim 55, further comprising a transmitter for transmitting a signal representative of activation to an individual located remotely.

58. The portable security unit according to claim 55, further comprising one of a camera and a microphone for collecting one of sound, pictures and video operating in conjunction with a transmitter for transmitting a signal representative of one of sound, pictures and video collected by one of said camera and microphone.

59. A security system for a closure leaf comprising:
a unit which pops into sight when the closure leaf is open and which returns to a retracted position as the leaf is closed,
wherein said unit incorporates a powered security component, which is switched on when the unit is in its popped out position and a linkage member extending between a portion of said security system secured adjacent to said closure leaf and a portion of said security system secured on said closure leaf;
wherein when pressure is exerted on said closure leaf beyond a predetermined level a security component is actuated.

60. The security system according to claim 59, wherein said security component incorporates a sprayer.

61. The security system according to claim 59, wherein said security component incorporates a camera.

62. The security system according to claim 59, wherein said unit is located in a cavity of said closure leaf adjacent portion and a bias is provided to cause said unit to pop out of the frame when the closure leaf is open.

63. The security system according to claim 59, wherein said closure leaf adjacent portion houses a canister for a sprayer, at least one battery and an alarm generator.

64. The security system according to claim 59, wherein said closure leaf adjacent portion incorporates means for securing said portion to the frame of the closure and said portion which is secured to the closure leaf incorporates means for securing the portion to the closure leaf and a strike plate for operational engagement with said unit; whereby when said closure leaf is closed the strike plate causes the unit to return to a retracted position and when the leaf is opened the strike plate is removed from said unit, whereby said unit is free to pop into sight.

65. A pressurized canister holder, comprising:
a housing into which a pressurize canister is placed in use,
an aperture allowing the contents of said canister to exit said housing, and
a trigger mechanism which acts on said canister to cause its contents to exit through said aperture;
wherein said housing incorporates two distinct oppositely located apertures; whereby spraying may be achieved from one of said selected apertures.
